(19) United States
(12) Patent Application Publication
(10) Pub. No.: US 2022/0107500 A1
(43) Pub. Date: Apr. 7, 2022

(54) CASCADED WAVEFRONT PROGRAMMING FOR DISPLAYS AND IMAGE SENSORS

(71) Applicant: Brelyon, Inc., Redwood City, CA (US)

(72) Inventors: Mohammadreza Khorasaninejad, Redwood City, CA (US); Barmak Heshmat Dehkordi, Redwood City, CA (US)

(73) Assignee: Brelyon, Inc., Redwood City, CA (US)

(21) Appl. No.: 17/494,671

(22) Filed: Oct. 5, 2021

Related U.S. Application Data
(60) Provisional application No. 63/087,777, filed on Oct. 5, 2020.

(51) Int. Cl. G02B 27/01; G02B 5/30

(52) U.S. Cl. CPC G02B 27/0172; G02B 2027/0174; G02B 5/3025

(57) ABSTRACT

Some implementations of the disclosure relate to a display system, including: a display that emits light corresponding to an image; and one or more optical control components configured to receive the light emitted by the display and modify one or more properties associated with the light as it passes through the one or more optical control components. Each optical control component includes a polarization-dependent metasurface. The one or more properties include: a direction the light travels, a position of the light, an angular distribution of the light, a perceived depth of the image, or a wavelength of the light that is filtered. Each optical control component is configured to dynamically switch between a first state where the optical control component modifies at least one property associated with the light, and a second state where the optical control component does not modify the at least one property.

### CROSS-REFERENCE TO RELATED APPLICATIONS

This application claims priority to U.S. Provisional Application No. 63/087,777 filed Oct. 5, 2020 and titled “METHODS AND SYSTEMS FOR CASCADED WAVEFRONT PROGRAMMING FOR DISPLAYS AND IMAGE SENSORS,” which is incorporated herein by reference in its entirety.

### TECHNICAL FIELD

The present disclosure generally relates to display and imaging systems. Particular embodiments of the present disclosure relate to systems and methods for cascaded wavefront programming for controlling light properties for light field displays or imaging systems.

### BACKGROUND OF THE INVENTION

There has been increasing traction toward more immersive light field and/or autostereoscopic three-dimensional (“3D”) displays due to advancements in optics, electronics, and nano/micro fabrications. Unlike stereoscopic 3D, light field displays manipulate optical wavefronts to create depth perception at the monocular level, which can eliminate the accommodation-vergence mismatch and reduce stress on the user's eyes.

There are four methods available for realizing more realistic light field experiences: super multi-view, computational, multi-focal, and holographic. Each method has unique weaknesses and advantages: The super multi-view method provides a light field at a compact form-factor but is limited to a reduced viewing zone and low resolution. The computational method increases resolution but produces haze and temporal flickering artifacts. The holographic method may struggle with color nonuniformity and fringing or specular artifacts. The multi-focal method can produce clean images; however, devices employing a multi-focal method are typically bulky.

The following issues are typical in all current light field display methods: large bandwidth requirements; a reliance on expensive and/or advanced components that are not easily mass-produced (e.g., tunable lenses); poor color uniformity; a small field of view or viewing zone; low brightness; low-resolution, haze, and diffraction artifacts; limited depth range; lack of compatibility with existing display drivers; and the occasional necessity to wear specialized glasses.

### SUMMARY OF THE INVENTION

Implementations of the disclosure relate to a display or imaging system that utilizes cascaded metasurfaces to dynamically program the wavefront of light.

In one embodiment, a display system comprises: a display configured to emit light corresponding to an image; and one or more optical control components configured to receive the light emitted by the display and modify one or more properties associated with the light as it passes through the one or more optical control components, wherein: each of the one or more optical control components comprises a polarization-dependent metasurface; the one or more properties associated with the light comprise: a direction the light travels, a position of the light, an angular distribution of the light, a perceived depth of the image corresponding to the light, or a wavelength of the light that is filtered; and each of the one or more optical control components is configured to dynamically switch between a first state where the optical control component modifies at least one property of the one or more properties associated with the light, and a second state where the optical control component does not modify the at least one property.

In some implementations, each of the one or more optical components comprises the polarization-dependent metasurface between a first tunable waveplate and a second tunable waveplate. In some implementations, the first tunable waveplate is a first switchable halfwave plate (HWP), and the second tunable waveplate is a second switchable HWP. In some implementations, each of the first switchable HWP and the second switchable HWP comprises a liquid crystal.

In some implementations, the display system further includes: a controller configured to apply, for each of the one or more optical control components, a control signal to the first tunable waveplate that switches the optical control component between the first state and the second state, wherein in one of the first state and the second state the first tunable waveplate affects a polarization of light passing through it, and wherein in the other of the first state and the second state the first tunable waveplate does not affect the polarization of light passing through it.

In some implementations, a first optical control component of the one or more optical control components is configured to modify the direction the light travels, the metasurface of the first optical control component comprising a first metagrating configured to diffract the light at a first angle it passes through the metagrating.

In some implementations, the one or more optical control components comprise a plurality of optical control components configured to modify the direction the light travels, the plurality of optical control components including the first optical control component and a second optical control component cascaded with the first optical control component, the metasurface of the second optical control component comprising a second metagrating configured to diffract the light at the first angle as it passes through the second metagrating, wherein when the first and second optical control components are in the first state, the light is diffracted at two times the first angle after it passes through the first and second optical control components.

In some implementations, the one or more optical control components comprise a first optical control component adjacent a second optical control component; the first and second optical control components are configured to modify the position of the light; the metasurface of the first optical control component comprises a first metagrating configured to diffract the light at a first angle as it passes through the first metagrating; and the metasurface of the second optical control component comprises a second metagrating configured to diffract the light at a second angle opposite the first angle as it passes through the second metagrating.

In some implementations, a first optical control component of the one or more optical control components is configured to modify the angular distribution of the light, the metasurface of the first optical control component comprising a meta-lens array configured to converge or diverge the light at a given polarization as it passes through the meta-lens array.

In some implementations, a first optical control component of the one or more optical control components is configured to modify the perceived depth of the image, the metasurface of the first optical control component comprising a meta-lens array configured to reimage one or more pixels associated with the image.

In some implementations, the one or more optical control components comprise a first optical control component including: a substrate having a first side and a second side opposite the first side, a first meta-grating on the first side of the substrate, a second meta-grating on the second side of the substrate; the first metagrating is configured to diffract a first wavelength of the light at a first angle as it passes through the first metagrating, and not diffract a second wavelength of the light as it passes through the first metagrating; and the second metagrating is configured to diffract the first wavelength of the light at a second angle, opposite the first angle, as it passes through the second metagrating, and not diffract the second wavelength of the light as it passes through the second metagrating.

In some implementations, each of the one or more optical control components is capable of switching between the first state and the second state at a frequency greater than a framerate of the display. In some implementations, the one or more optical control components of the display system are configured to shift the image by less than a length of a pixel of the image to create a higher resolution image at a lower frame rate. In some implementations, the display comprises a plurality of display pixels; and the one or more optical control components comprises multiple optical controls, each of the multiple optical control components positioned over a respective one of the multiple display pixels to shift the position of light emitted by the pixel when the optical control component is in the first state.

In some implementations, each of the one or more optical control components is capable of switching between the first state and the second state at a frequency at least two times greater than a framerate of the display, and each of the one or more optical control components of the display system are configured to create an image having a framerate at least two times greater than the display.

In some implementations, each of the one or more optical components comprises the polarization-dependent metasurface between a first tunable wave plate and a cascaded set of tunable waveplates such that at each polarization angle or state the overall cascade performs a desired set of optical functionalities.

In some implementations, the display system is a tessellated display configured to expand a viewed size of the image; the display system further comprises at least two mirrors placed normal to a surface of the display; and the first optical component is configured to cause the light to travel in the direction of one of the two mirrors.

In some implementations, the one or more optical control components comprise a first optical control component and a second optical control component; the first optical control component is configured to modify the direction the light travels to control a destination that the light travels to; and the second optical component is configured to modify the angular distribution of the light to control a size of a viewable zone of the image.

In one embodiment, an image capture system comprises an aperture configured to receive light; a first optical component configured to collect the light received at the aperture; one or more optical control components configured to receive the light passed by the first optical component and modify one or more properties associated with the light as it passes through the one or more optical control components, wherein: each of the one or more optical control components comprises a metasurface; the one or more properties associated with the light comprise: a direction the light travels, a position of the light, an angular distribution of the light, a perceived depth of an image corresponding to the light, or a wavelength of the light that is filtered; and each of the one or more optical control components is configured to switch between a first state where the optical control component modifies at least one property of the one or more properties associated with the light, and a second state where the optical control component does not modify the at least one property; and an image sensor configured to receive the light after it passes through the one or more optical control components.

In some implementations of the image capture system, the one or more optical control components comprise: a depth control module positioned over the image sensor, the metasurface of the depth control module comprising a meta-lens array configured to reimage one or more pixels associated with the image; or an angular distribution control module positioned over the image sensor, the metasurface of the angular distribution control module comprising a meta-lens array configured to converge the light at a given polarization as it passes through the meta-lens array, thereby converging the light on an active region area of the image sensor.

Other features and aspects of the disclosure will become apparent from the following detailed description, taken in conjunction with the accompanying drawings, which illustrate, by way of example, the features in accordance with various embodiments. The summary is not intended to limit the scope of the invention, which is defined solely by the claims attached hereto.

### BRIEF DESCRIPTION OF THE DRAWINGS

The technology disclosed herein, in accordance with one or more embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram showing a display system that may shape the wavefront of light emitted from a display, in accordance with some implementations of the disclosure.

FIG. 2A shows an example of a passive shutter for controlling the direction of light, in accordance with some implementations of the disclosure.

FIG. 2B shows an example of a passive shutter for controlling the direction of light, in accordance with some implementations of the disclosure.

FIG. 2C shows an example of a passive shutter for controlling the direction of light, in accordance with some implementations of the disclosure.

FIG. 2D shows an example of a passive shutter for controlling the direction of light, in accordance with some implementations of the disclosure.

FIG. 2E shows an example of an active shutter for controlling the direction of light, in accordance with some implementations of the disclosure.

FIG. 2G shows an example of an active shutter for controlling the direction of light, in accordance with some implementations of the disclosure.

FIG. 2H shows an example of an active shutter for controlling the direction of light, in accordance with some implementations of the disclosure.

FIG. 2I shows an example of an active shutter for controlling the direction of light, in accordance with some implementations of the disclosure.

FIG. 2J shows an example of an active shutter for controlling the direction of light, in accordance with some implementations of the disclosure.

FIG. 2K shows an example of an active shutter for controlling the direction of light, in accordance with some implementations of the disclosure.

FIG. 2L shows an example of an active shutter for controlling the direction of light, in accordance with some implementations of the disclosure.

FIG. 3A is a block diagram showing components of a direction control module, in accordance with some implementations of the disclosure.

FIG. 3B shows an example of stacking multiple direction control modules, in accordance with some implementations of the disclosure.

FIG. 3C shows a ray-tracing simulation when placing direction control modules in front of a display that emits collimated light, in accordance with some implementations of the disclosure.

FIG. 3D shows a ray-tracing simulation when placing direction control modules in front of a display that emits diverging light, in accordance with some implementations of the disclosure.

FIG. 4A shows an aperture that controls an angular distribution of light, in accordance with some implementations of the disclosure.

FIG. 4B shows an aperture that controls an angular distribution of light, in accordance with some implementations of the disclosure.

FIG. 4C shows an aperture that controls an angular distribution of light, in accordance with some implementations of the disclosure.

FIG. 4D is a chart showing the field of view of an aperture as a function of the width of the aperture and distance of the aperture from a display pixel, in accordance with some implementations of the disclosure.

FIG. 5A is a block diagram showing components of an angular distribution control module, in accordance with some implementations of the disclosure.

FIG. 5B shows an example of stacking multiple angular distribution control modules, in accordance with some implementations of the disclosure.

FIG. 5C shows an angular distribution control module including a meta-lens that generates converging rays out of diverging incident rays, in accordance with some implementations of the disclosure.

FIG. 5D shows an angular distribution control module including a meta-lens that generates collimated rays out of diverging incident rays, in accordance with some implementations of the disclosure.

FIG. 5E shows an angular distribution control module including a meta-lens that increases the divergence angles of incoming diverging incident rays, in accordance with some implementations of the disclosure.

FIG. 6A is a block diagram showing components of a position control module, in accordance with some implementations of the disclosure.

FIG. 6B shows an example of stacking multiple position control modules, in accordance with some implementations of the disclosure.

FIG. 6C shows an example of two identical cascaded position control modules that deflect incident light to an angle and bring back the light to its original angle, in accordance with some implementations of the disclosure.

FIG. 6D shows an example of two identical cascaded position control modules that deflect incident light to an angle and bring back the light to its original angle, in accordance with some implementations of the disclosure.

FIG. 6E shows an example matrix of pixels that may be position-shifted by a distance half the length of a pixel by position control modules, in accordance with some implementations of the disclosure.

FIG. 6F illustrates an example method of using position control modules to shift the positions of pixels of a superpixel to provide a higher frame rate image, in accordance with some implementations of the disclosure.

FIG. 7A is a block diagram showing components of a depth control module, in accordance with some implementations of the disclosure.

FIG. 7B shows an example of cascading multiple depth control modules, in accordance with some implementations of the disclosure.

FIG. 7C shows depth distribution control module including a meta-lens array that reimages display pixels at a location in front of a display, in accordance with some implementations of the disclosure.

FIG. 7D shows depth distribution control module including a meta-lens array that reimages display pixels at a location behind a display, in accordance with some implementations of the disclosure.

FIG. 8A shows components of a color corrector module based on an aperture combined with color filters, in accordance with some implementations of the disclosure.

FIG. 8B shows components of a color corrector module based on an aperture combined with color filters, in accordance with some implementations of the disclosure.

FIG. 8C shows components of a color corrector module based on an aperture combined with color filters, in accordance with some implementations of the disclosure.

FIG. 8D shows components of a color corrector module based on an aperture combined with color filters, in accordance with some implementations of the disclosure.

FIG. 9A shows a design of a color corrector module including two metagratings on opposite sides of a substrate, in accordance with some implementations of the disclosure.

FIG. 9B is a plot showing the phase of different wavelengths of light as it passes through the color corrector module of FIG. 9A, in accordance with some implementations of the disclosure.

FIG. 9C shows a design of a color corrector module including two metagratings on opposite sides of a substrate, in accordance with some implementations of the disclosure.

FIG. 9D is a plot showing the phase of different wavelengths of light as it passes through the color corrector module of FIG. 9C, in accordance with some implementations of the disclosure.

FIG. 10 shows a display system that provides dynamic control of the viewable zone of the display by stacking several control modules, in accordance with some implementations of the disclosure.

FIG. 11 shows a tessellated display system that may expand the display size by stacking several control modules together with mirrors using a tessellation mechanism, in accordance with some implementations of the disclosure.

FIG. 12A shows a display system that stacks multiple control modules to dynamically change the depth of the display and generated 3D contents, in accordance with some implementations of the disclosure.

FIG. 12B shows a display system that stacks multiple control modules to dynamically change the depth of the display and generated 3D contents, in accordance with some implementations of the disclosure.

FIG. 13A shows an imaging system with an angular distribution control module on top of an image sensor, in accordance with some implementations of the disclosure.

FIG. 13B shows an imaging system with a position control module an angular distribution control module stacked over an image sensor to adjust both direction and angular distribution of incoming light, in accordance with some implementations of the disclosure.

FIG. 13C shows an imaging system that includes a depth control module on top of an image sensor so that the imaging system can change the depth where the camera is capturing images from a scene, without any mechanical movement, in accordance with some implementations of the disclosure.

FIG. 13D shows an imaging system that cascades a direction control module and angular distribution control module to increase the spatial resolution of an image sensor, in accordance with some implementations of the disclosure.

FIG. 14A shows a display system where control modules and several other optical components are cascaded and integrated into a display to enhance or expand its functionality, in accordance with some implementations of the disclosure.

FIG. 14B shows an imaging system including an image sensor and multiple control modules and several other optical components that are cascaded and integrated to enhance or expand the image sensor's functionality, in accordance with some implementations of the disclosure.

FIG. 15 illustrates a chip set in which embodiments of the disclosure may be implemented.

The figures are not intended to be exhaustive or to limit the invention to the precise form disclosed. It should be understood that the invention can be practiced with modification and alteration, and that the disclosed technology be limited only by the claims and the equivalents thereof.

### DETAIL DESCRIPTIONS OF THE INVENTION

As used herein, the term “optically coupled” is intended to refer to one element being adapted to impart, transfer, feed or direct light to another element directly or indirectly.

Throughout this disclosure, the term “arbitrarily engineered” is used to refer to “of being any shape, size, material, features, type or kind, orientation, location, quantity, components, and arrangements of components with single or an array of components that would allow the methods, the systems, the apparatuses, and the devices described in the present disclosure or a specific component of the methods, the systems, the apparatuses, and the devices to fulfill the objectives and intents of the present disclosure or that specific component within the methods, the systems, the apparatuses, and the devices.” In this disclosure, light field at a plane refers to a vector field that describes the amount of light flowing in every or several selected directions through every point in that plane. The light field is the description of the angle and intensity of light rays traveling through that plane.

In the present disclosure, display refers to an emissive display which may be based on any technology such as but not limited to Liquid Crystal Displays (“LCD”), Thin-film Transistor (“TFT”), Light Emitting Diode (“LED”), Organic Light Emitting Diode arrays (“OLED”), Active Matrix Organic Light Emitting Diode (“AMOLED”), projection or angular projection arrays on flat-screen or angle-dependent diffusive screen or any other display technology) and/or mirrors and/or half-mirrors and/or switchable mirrors or liquid crystal sheets arranged and assembled in such a way as to exit bundles of light with divergence apex at different depths or one depth from the core plane or waveguide-based displays. The display might be a near-eye display for a headset, a near-head display, or far standing display. The application of the display does not impact the principle of this invention and this is what is referred to by an emissive display in this disclosure.

In the present disclosure, metasurface is an arbitrary array of subwavelength nanostructures that collectively control the basics properties of light such as amplitude, phase, polarization, direction, and sometimes combinations of them at the same time. Examples of metasurfaces are described in P. Genevet, F. Capasso, F. Aieta, M. Khorasaninejad, and R. C. Devlin “Recent advances in planar optics: from plasmonics to dielectric metasurfaces” Optica, 4, (2017). A metasurface can be a meta-lens/metalens (metasurface based lens that converges or diverges the light based on a focal distance), meta-grating/metagrating (grating based on metasurface design), or meta-hologram/metahologram (hologram based on metasurface). Examples of metalenses are described in M. Khorasaninejad and F. Capasso “Metalenses: versatile multifunctional photonic components” Science, 358, eaam8100, (2017). Examples of meta-gratings are described in M. Khorasaninejad and F. Capasso “Broadband multifunctional efficient meta-gratings based on dielectric waveguide phase shifters” Nano Letters, 15 (2015). Examples of meta-holograms are described in M. Khorasaninejad, A. Ambrosio, P. Kanhaiya, and F. Capasso “Broadband and chiral binary dielectric meta-holograms” Science Advances, 5 (2016). Metasurfaces' building blocks can be made of a semiconductor such as (amorphous silicon polycrystalline silicon, gallium phosphide, gallium nitride, silicon carbide), crystal such as (silicon, lithium niobate), a dielectric such as (silicon dioxide, silicon nitride, hafnium oxide, titanium dioxide), a polymer such as (photoresist, PMMA), a metal such as (gold, silver, aluminum), or phase change materials such as (vanadium dioxide, chalcogenide) or a combination of them. These structures are typically made by processes such as optical lithography, electron beam lithography, nanoimprinting, reactive ion etching electron beam deposition sputtering, plasma-enhanced deposition, atomic layer deposition, and any combination of the aforementioned processes with arbitrary order. The process of manufacturing the layer is out of the focus of this disclosure and does not impact the proposed systems and methods.

In the present disclosure, the polarization state of light may be linear polarization, circular polarization, elliptical polarization, or any combination thereof. The polarization of the light is defined as a temporal and spatial status of the electric field with regard to the propagation direction of the light.

Throughout this disclosure, the angular profiling may be achieved by holographic optical elements (“HOE”), diffractive optical elements (“DOE”), lens, concave or convex mirrors, lens arrays, microlens arrays, aperture arrays, optical phase or intensity masks, digital mirror devices (“DMDs”), Spatial light modulators (“SLMs”), metasurfaces, diffraction gratings, interferometric films, privacy films, thin-film stack or other methods. Intensity profiling may be achieved by absorptive or reflective polarizers, absorptive or reflective coatings, gradient coatings, or other methods. The color or wavelength profiling may be achieved by color filters, absorptive or reflective notch filters, interference thin films, or other methods. The polarization profiling might be done by metasurfaces with metallic or dielectric, micro or nanostructures, wire grids, absorptive or reflective polarizers, wave plates such as quarter-waveplates, half-waveplates, 1/x waveplates, or other nonlinear crystals or polymer with anisotropy.

All such components may be arbitrarily engineered to deliver the desired profile. As used herein, “arbitrary optical parameter variation” refers to variations, change, modulation, programing and/or control of parameters which may be one or a collection of following variations namely: optical zoom change, aperture size, and aperture brightness variation, focus variation, aberration variation, focal length variation, time-of-flight or phase variation in case of an imaging system with time-sensitive or phase-sensitive imaging sensor, color variation or spectral variation in case of spectrum sensitive sensor, the angular variation of a captured image, variation in depth of field, the variation of depth of focus, the variation of coma, variation of stereopsis baseline in case of stereoscopic acquisition, the variation of a field of view of the lens.

Throughout the present disclosure, the imaging sensor might use “arbitrary image sensing technologies” to capture light or a certain parameter of light that is exposed to it. Examples of such “arbitrary image sensing technologies” include complementary-symmetry metal-oxide-semiconductor (“CMOS”), scientific CMOS (sCMOS), Single Photon Avalanche Diode (“SPAD”) array, Charge-Coupled Device (“CCD”), Intensified Charge-Coupled Device (“ICCD”), Ultra-fast Steak sensor, Time-of-Flight sensor (“ToF”). Schottky diodes or any other light or electromagnetic sensing mechanism for shorter or longer wavelengths.

Throughout the present disclosure, dynamic design or dynamic components or generally the adjective dynamic refers to a design or component that has variable optical properties that can be changed with an optical or electrical signal. Electro-optical materials such as liquid crystals or piezoelectric materials or nonlinear crystals are a few examples of such materials. A passive design or component is referred to as a design that does not have any dynamic component other than the display.

Throughout the present disclosure, the pass angle of a polarizer is the angle in which the incident light with the normal incident angle (that is perpendicular) to the surface of the polarizer can pass through the polarizer with maximum intensity. The “pass axis” is the axis or the vector with the pass angle such that the light with polarization at such vector passes through a linear polarizer

When two items are cross-polarized, it means their polarization status or orientation is in orthogonal status with regards to one another. For example, when two linear polarizers are cross-polarized; it means that their pass angle has a 90 degrees difference.

Throughout the present disclosure, the reflective polarizer is a polarizer that allows light that has polarization aligned with the pass angle of the polarizer to transmit through the polarizer, and it will reflect the light that is cross-polarized with its pass axis. A wire grid polarizer (a reflective polarizer made with nano wires aligned in parallel) is a non-limiting example of such a polarizer.

Throughout the present disclosure, an absorptive polarizer is a polarizer that allows light with polarization aligned with the pass angle of the polarizer to pass through, and it absorbs cross-polarized light.

Throughout the present disclosure, imaging system refers to any apparatus that acquires an image that is a matrix of information about light intensity and/or its other, temporal, spectral, polarization or entanglement or other properties used in any application or framework such as cellphone cameras, industrial cameras, photography or videography cameras, microscopes, telescopes, spectrometers, time-of-flight cameras, ultrafast cameras, thermal cameras, or any other type of camera.

Throughout the present disclosure, aperture refers to a structure having a single hole/opening or array of holes/openings in which light can pass through the structure. These openings or holes are surrounded by an area that blocks the light. The blocking mechanism can be based on different approaches, including not limited, to absorption (e.g., metal, black material) or reflection (e.g., metal, thin-film dielectric). Openings and holes can be filled with other material/medium/films to give extra functionalities to the aperture including, but not limited to, making the aperture color selective, angle selective, polarization selective, and amplitude selective.

Throughout the present disclosure, a color filter refers to a filter that only allows specific wavelengths of light (e.g., wavelength range) or colors of light to pass through. The mechanism behind color filtering can be based on absorption (e.g., using a die, pigment, metallic nanostructure, etc.), reflection (e.g., thin film, metallic nanostructure), or diffraction (e.g., reflective or transmission grating) of a specific color or colors.

As discussed above, there are a number of challenges that have significantly limited the use of or production of light field displays in commercial and/or industrial settings. For example, the success of cellphone cameras has increased the need for higher lens brightness to improve performance in dark environments and provide more flexible optical parameters at the hardware level without the need for computational restoration of the image. Some proposed techniques for generally modifying the wavefront of the light field while reducing the form factor include utilizing lenslet arrays, diffractive optics, and apertures. However, these techniques suffer from some associated shortcomings or challenges such as color and diffractive artifacts, limited field of view, and low image resolution. Accordingly, although there have been ongoing efforts to control the wavefront of light through passive diffractive elements, holographic layers, and/or lenticular microlens structures, these three methods induce significant haze, speckle artifact, and/or chromatic artifacts.

Therefore, there is a need for improved methods and systems for effectively controlling the wavefront of light with minimal artifacts that may overcome one or more of the above-mentioned problems and/or limitations.

To this end, the present disclosure describes systems and methods for dynamically controlling light propagation direction, angular distribution, and polarization in a display or imaging system, and, particularly, a light field display or imaging system. In accordance with implementations, a display or imaging system utilizes cascaded metasurfaces to dynamically program the wavefront of light. The system may include a stack of metasurfaces and liquid-crystal layers that may be controlled to programmatically control light propagation direction, angular distribution, and polarization as light moves through the different layers in the display or imaging system. For example, in a display system, these layers may be used to provide different images at different viewing angles from a display. These layers may also or alternatively be used to control image resolution, frame rate, brightness, color, and/or other properties of the display. One or more control modules of the system may provide dynamic control of the system by applying one or more electric signals that change optical properties of optical components described herein. Multiple control modules may be stacked together to increase the overall function.

As such, implementations of the present disclosure describe an approach based on metasurfaces and other flat optical technology such as liquid crystals for efficient and dynamic control of the wavefront of light or directionality of the light. The dynamic nature of these approaches along with the higher efficiency of metasurfaces significantly enhances the performance and flexibility of optical systems, especially for displays and imaging applications. For example, by virtue of using the cascaded metasurfaces, further described herein, it may be possible to dynamically program light propagation direction, angular distribution, and polarization for different pixels of an image. As further discussed below, this may be particularly advantageous in the context of light field and directional displays as well as imaging systems.

As further described below, by virtue of implementing the foregoing design including cascaded metasurfaces, it is possible to program the wavefront of light in a binary fashion. The foregoing technology may be used to optically adjust the frame rate and/or resolution of a display. For example, consider a panel having a maximum resolution of 8K that runs at 60 Hz frame rate. By having cascading metasurfaces in front of the display, it may be possible to shift the display resolution to 4K and frame rate to 240 Hz.

Further, some implementations of the present disclosure describe the light field for multiple users. Further, some implementations of the present disclosure relate generally to tiling the light field for increasing resolution and/or field of view of displays and/or imaging apparatuses via time multiplexing or spatial multiplexing. Further, the present disclosure describes optical and computational methods that may use a set of algorithms and reflectors, thin films, metasurface, polarization film, diffractive elements, and/or refractive elements to control properties of light for display or imaging purposes.

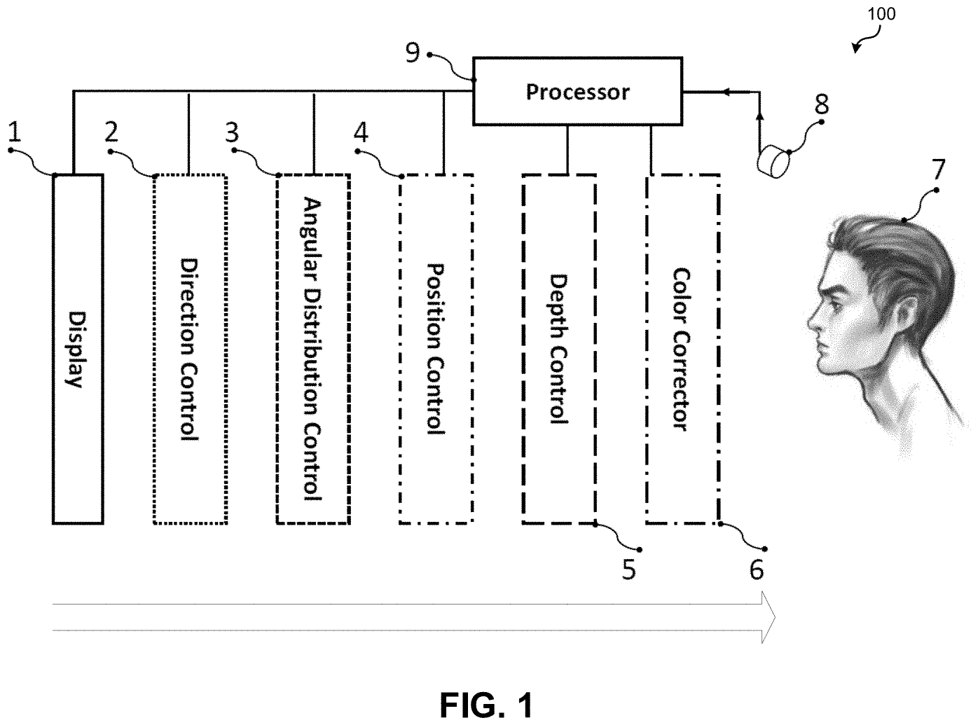

FIG. 1 is a block diagram showing a display system 100 that may shape the wavefront of light emitted from a display 1, in accordance with some implementations of the disclosure. The display system 100 includes multiple cascaded control modules 2-6. During operation, light emitted from an emissive display 1 passes through the cascaded control modules 2-6 before reaching the user 7. The arrow shows the light emitted from the display to the user from left to right. Here, display 1 is an emissive display or a source of a light field that may be arbitrarily engineered. The control modules 2-6 may impact the various properties of light emitted from display 1 including, but not limited to, the propagation direction, angular profile, polarization, and perceived depth. The order and arrangement of control modules 2-6 may vary depending on the implementation of system 100. The control modules 2-6 may either work together or individually to impact the properties of the light emitted by the display 1. The control modules 2-6 may be placed before the display 1 in the case of a transparent (see-through) display such as those used with augmented reality glasses. In the case of a liquid-crystal display (LCD) or other display that utilizes a backlight, the control modules 2-6 may be integrated with the backlight module. It should be noted that depending on the implementation of the display system, only some of the control modules 2-6 may be present (e.g., light only passes through a control module 2 and 4). Additionally, a plurality of one type of control module (e.g., direction control) may be used in some implementations. In some cases, Light may reflect back and forth between at least two control modules before reaching the user's eyes.

In this example, display system 100 also includes a head and/or eye tracking sensor 8. Sensor 8 may be a simultaneous localization and mapping sensor (SLAM) or an image sensor or camera. Sensor 8 is configured to collect and feedback head/eye tracking data of the user 7 to the source that generates the content that is displayed by display 1, thereby controlling how images are perceived by the user 7. For example, based on the location, gesture, and/or eye gaze of the user 7, sensor 8 may provide feedback or tracking data to a processor 9 of the system. Using the received tracking data, the processor 9 may send one or more signals to one or more control modules 2-6 to modify the wavefront of light before it reaches the user 7. This feedback system and processing of the tracking data by processor 9 may improve the quality of the image perceived by one or more users 7, eliminate color artifact, eliminate diffractive artifact, and/or eliminate other possible artifacts. In some implementations, the presented content is not adaptively changed, and sensor 8 and/or processor 9 are not included in system 100.

### Direction Control Module/Component

As described herein, a direction control module (DCM) 2 may be used to control the direction of light.

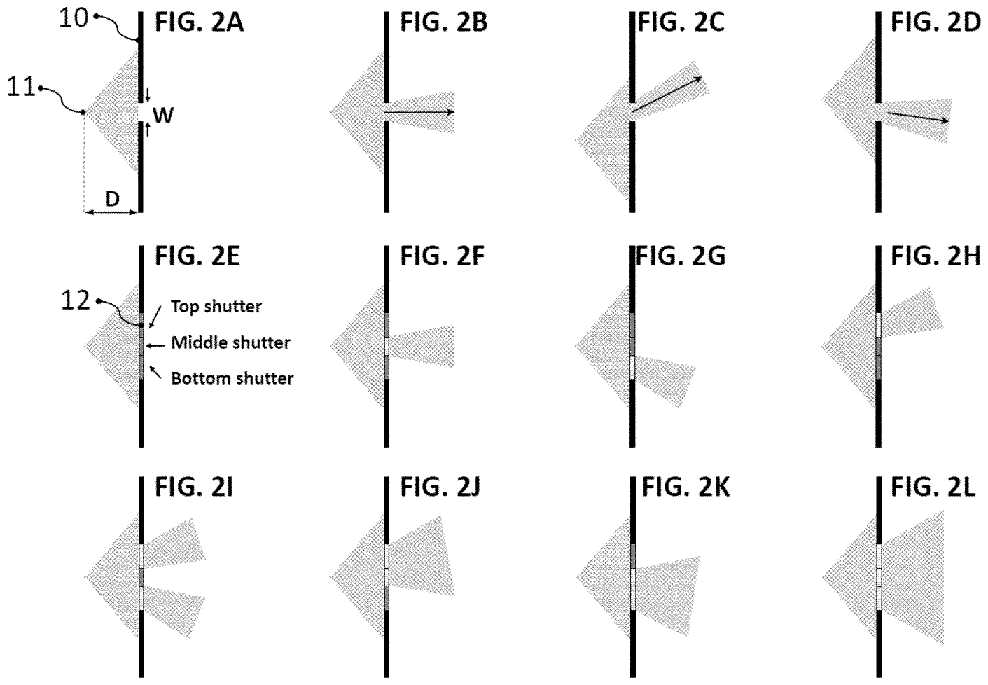

FIGS. 2A-L show schematic diagrams of DCMs 2 implemented with apertures 10 that control the direction of light in static or dynamic fashions, in accordance with some implementations of the disclosure. FIGS. 2A-2D depict examples of passive shutters. FIG. 2A shows an aperture 10 with a width of W and distance of D from a display pixel 11. In this example, a pixel is approximated by a point source. As depicted by FIGS. 2B-2D, by shifting the center of the aperture 10 relative to the position of the pixel 11, the direction of light propagation may be adjusted. In addition, one may further finetune the direction of light-propagation by adjusting the aperture's width and its distance from the pixel (D). FIG. 2B shows a case where the center of the aperture is aligned with the pixel position. After passing through the aperture, light propagates forward with a reduced Field of View (FoV) or reduced angle of divergence. FIG. 2C shows a case where the center of the aperture is moved up relative to the pixel, resulting in upward propagation of light. FIG. 2D shows that by moving down the center of the aperture relative to the pixel, the output light may be directed downward.

FIGS. 2E-2L depict examples of active apertures. As shown in FIG. 2E, the opening of the aperture 10 is filled with three shutters 12 that may be turned “ON” and “OFF” independently. The “ON” state shutter allows the light to passes through and in the “OFF” state blocks the incoming light. One example of a shutter may be liquid crystal (LC). By using different combinations of ON and OFF states of the shutters, the functionality of the aperture may be significantly expanded compared to the passive case. For example, by arbitrarily engineering the shutters, one can simultaneously control the light direction and its FoV.

Although using apertures may be straightforward and effective, it comes at the cost of losing significant light intensity because of the absorption of part of the light. For example, this has been a limiting factor for many angular displays that use parallax barriers. The other disadvantage of apertures is that one cannot control the direction of light propagation without affecting other characteristics of light such as its angular distribution and diffraction from edges, especially if sub-apertures are smaller than 20 microns by 20 microns in dimension.

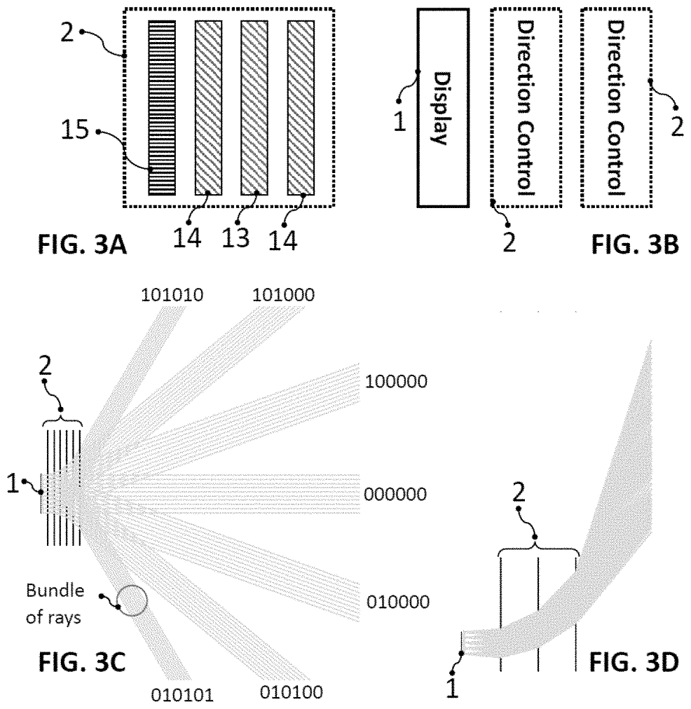

FIGS. 3A-3D show the use of DCMs 2 implemented with metasurface based gratings (meta-gratings), in accordance with some implementations of the disclosure. FIG. 3A is a block diagram showing a DCM 2 that uses a meta-grating 13 to solve the aforementioned problems that parallax barriers or passive aperture arrays may have. In the diagrams of FIGS. 3A-3D, the light is propagating from left to right.

As shown, the DCM 2 of FIG. 3A includes a polarizer 15 that polarizes input light, a first switchable HWP 14 that receives the polarized light, a meta-grating 13, and a second switchable HWP. In this case, a switchable HWP refers to a HWP that can be dynamically turned ON and OFF. In the OFF state, it does not affect the polarization of light, and in the ON state it acts as HWP retarding the phase of the electric field of light by 90 degrees. One example of a HWP can be based on a Liquid Crystal (LC) layer sandwiched between two transparent conductive layers such that when a voltage is applied to the LC layer, the HWP is turned ON and the polarization of the light is rotated 90 degrees, and when there is no voltage applied, the polarization is left intact.

In some cases, the polarizer 15 may be omitted. Otherwise, it polarizes the light before the HWP 14. In this example, meta-grating 13 is designed to diffract light for a first polarization of light and allow a second polarization of light, orthogonal to the first polarization, to pass unperturbed. As meta-grating 13 may convert the polarization when diffracting incoming light, another HWP 14 (e.g., another LC) is placed right after the meta-grating to control the output light polarization at will. Multiple DCMs 2 having the components depicted in FIG. 3A may be used to achieve additional control. For example, FIG. 3B shows one example of stacking (cascading) multiple DCMs 2 to change the direction of light at will in a discreet manner.

FIG. 3C shows a ray-tracing simulation when placing 6 DCMs in front of a display 1 that emits collimated light. Collimated light is selected for ease of visualization in this example, but it should be noted that light may have any arbitrary angular distribution. In this example, the first DCM (closest to the display on the left side of the stack), third DCM, and fifth DCM are similar and change the angle of normally incident light by 20 degrees upwards. The second DCM, fourth DCM, and sixth DCM are similar and change the angle of incident light by 20 degrees downwards. It should be noted that although FIG. 3C depicts all possible options for directionally controlling light, in reality, at any time (e.g., frame), only one bundle of light would come out of this assembly of six DCMs. The binary number noted at the end of the rays' bundle illustrates the status of each of the DCMs (ON or OFF). For example, “101010” is the case were first, third, and fifth DCM are ON and second, fourth, and sixth DCM are OFF. In this example, collimated rays from the display (horizontal rays) first will be deflected 20 degrees upward by the first DCM, then deflected another 20 degrees upward by the third DCM, and finally, another 20 degrees upward by the fifth DCM, at this point rays' angle is 60 degree. When all CDMs are OFF, i.e., “000000”, the output angle remains unchanged. One can deflect rays to −40 degree (downward) by turning ON the second and forth CDM and keep the rest OFF. In that case, the “010100” signal is given to the DCM stack. FIG. 3D considers a pixel whose rays are not collimated (they have fan-out meaning the light is diverging). In this example, the same designed is used to redirect the incoming light upward.

### Angular Distribution Control Module/Component

As described herein, an angular distribution control module (ADCM) 3 may be used to control the angular distribution of light.

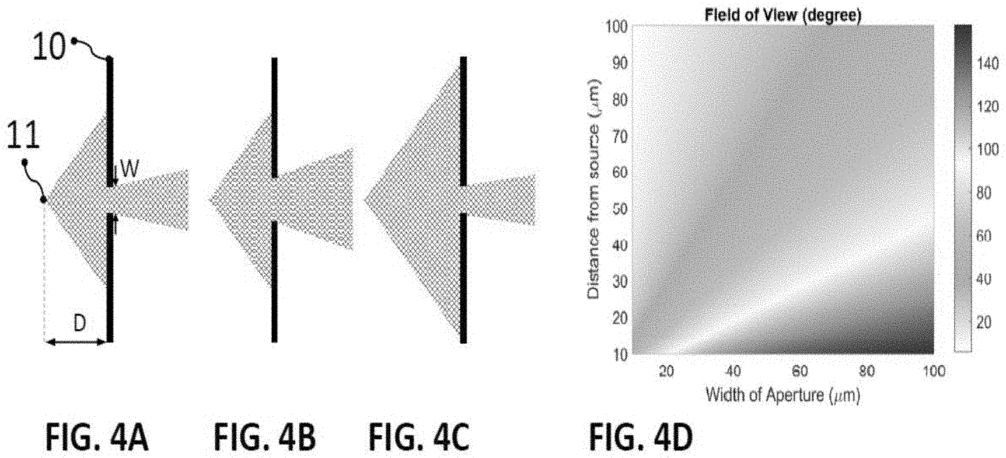

FIGS. 4A-4D show an implementation of a dynamic ADCM 3 based on an aperture design, in accordance with some implementations of the disclosure. FIG. 4A shows an aperture with a width of W and distance of D from the display pixel (approximated as a point source). As depicted by FIGS. 4A-4C, by adjusting the aperture parameters, (W and D), one can control the light angular distribution (after aperture). The FoV is a function of W and D calculated by the Ray-Tracing method, and it is depicted by the chart of FIG. 4D. A smaller aperture reduces the divergence angle when the aperture diameter is over ten times larger than the wavelength of the light. Here, a 1D aperture is assumed (with a finite width of W and an infinite length, perpendicular to the screen) with its center aligned to the pixel, therefore, resulting in symmetric FoV. As anticipated, by increasing the aperture's width, the FoV can be increased. Also, by placing the aperture further away from the pixel (larger D), FoV can be reduced. Although apertures may provide a straightforward way to adjust the angular distribution or divergence of light from a pixel, they have multiple shortcomings. They absorb the majority of light, thus resulting in brightness reduction. Also there is no dynamic mechanism that one can use with the aperture design to adjust the angular distribution at different times.

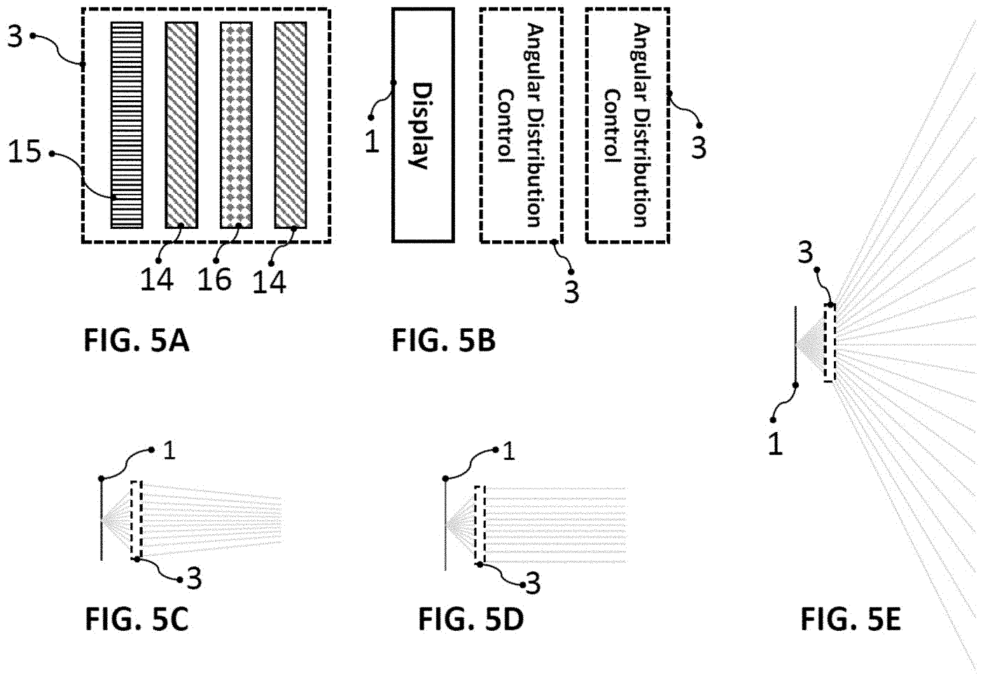

To address the foregoing shortcomings of apertures for controlling the angular distribution of light, FIGS. 5A-5E show an implementation of an ADCM 3 based on a meta-lenses (metasurface based lenses) design, in accordance with some implementations of the disclosure.

FIG. 5A is a block diagram illustrating an example structure of the ADCM 3. The ADCM 3 includes a polarizer 15 that polarizes input light and a polarization-dependent meta-lens array 16 between a first switchable HWP 14 and a second switchable HWP 14. The polarizer 15 before the first switchable HWP 14 is optional, and it may be used to set the input polarization if required. Each meta-lens of the meta-lens array 16 applies optical power (either positive or negative depending on design, meaning it converges or diverges the incoming light) on the desired polarization and lets the other polarization pass unperturbed. Therefore, the angular distribution of each pixel (or in general, incoming rays) may be controlled with negligible loss in intensity of the light. Since no light or a minimal amount of light is lost in this process, the narrower the angle of each pixel after the ADCM 3, the brighter the image will be. As such, this technique can help to increase the brightness of the image. For example, as depicted in the example of FIG. 5C, which generates converging rays out of diverging incident rays, the intensity of light reaching the user with a distance of 70 cm from the display 1 increases 16.5 times compared to the case of not having a meta-lens. This process can also be used with a sensor 8 (e.g., SLAM) to provide the brightest image in all desired angles. FIGS. 5C-E show three different example designs of a meta-lens. In these three designs, the meta-lens generates converging rays out of diverging incident rays (FIG. 5C); the meta-lens generates collimated rays out of diverging incident rays (FIG. 5D); and the meta-lens increases the divergence angles of incoming diverging incident rays (FIG. 5E). One of the advantageous aspects of this design is that the ADCM 3 may be turned ON and OFF. By switching between the two desired states, it is possible to cascade the ADCMs. Multiple ADCMs 3 having the components depicted in FIG. 5A may be used to achieve additional control. For example, if there is an N number of ADCM 3, the output angular distribution may be controlled in 2^{N} different ways. FIG. 5B shows one example of stacking (cascading) multiple ADCMS 3.

### Position Control Module/Component

As described herein, an a position control module (PCM) 4 may be used to control the position of light.

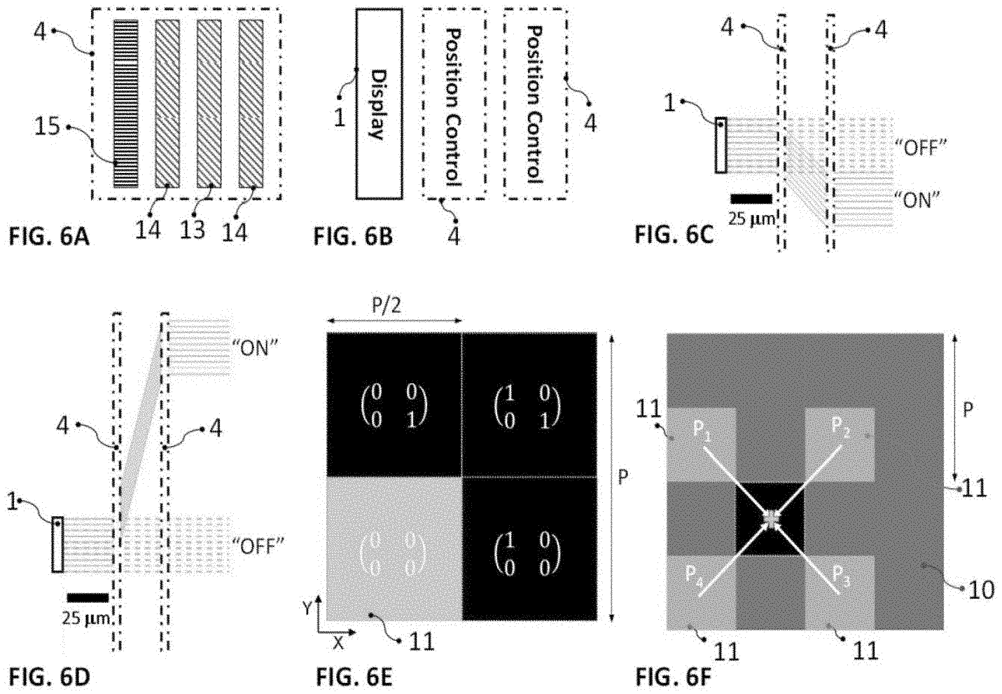

FIGS. 6A-D show an implementation of a PCM 4 based on a meta-gratings design, in accordance with some implementations of the disclosure.

FIG. 6A is a block diagram illustrating an example structure of a PCM 4. The PCM 4 includes a polarizer 15 that polarizes input light and a polarization-dependent meta-grating 13 between a first switchable HWP 14 and a second switchable HWP 14. The polarizer 15 before the first switchable HWP 14 is optional, and it may be used to set the input polarization if required. The meta-grating 13 deflects the incident light to a designed angle for a desired polarization and lets the other polarization pass through unperturbed (switchable functionality via controlling input polarization). As depicted by FIGS. 6B-6D, two identical PCMs 4 are cascaded. The first PCM 4 deflects the incident light to the design angle and the second PCM 4 returns it to its original angle. For example, as shown in FIG. 6C, the first PCM 4 (closer to display 1) deflect rays downward (e.g., −45 degrees), and the second PCM 4 bring the rays back to their original values (in “ON” state). Through this process utilizing dual PCM 4, the angle of the light rays is not changed, but rather only their vertical positions. In the OFF-state, when the light is in the orthogonal state, rays pass through both PCMs 4 unperturbed, and both the angle and position of the rays remain unchanged. FIG. 6D, show an example where the rays are position shifted further upwards by first deflecting them by 75 degrees and then bringing them back to their original angle by the second PCM, therefore changing the vertical position or coordinate. Any number of PCMs 4 as required may be stacked to arbitrarily change the position of rays in three-dimensional space (e.g., along the XYZ coordinates). PCMs 4 may also be stacked with other modules discussed in the disclosure to perform more sophisticated light control.

In some implementations, this position change may be used to change display frame rate by using super-resolution algorithms. The entire matrix of the pixels may be shifted by a size smaller than the length of a pixel (depending on the filling factor of the pixel active region), thereby creating a higher resolution image at a lower frame rate. For example, as depicted by FIG. 6E, consider the case where the position can be shifted by a 2×2 matrix with a length half the size of a pixel at x and y. Then if the display panel has a framerate f (e.g., 240 Hz) with 1000×1000 resolution, the PCM is activated at the frameratef(e.g., 240 Hz) to sequentially change the position of the image to (0,0) (0,0.5 P) (0.5 P,0) and (0.5 P,0.5 P) in the (x,y) plane. Here, P refers to the pitch of the pixel, and a 50% filling factor is assumed. This vector of translations may be referred to as a translation matrix given by Equation (1):

$$[ \begin{matrix}{x}_{t} \\ {y}_{t}\end{matrix} ] = [ \begin{matrix}a & b \\ c & d\end{matrix} ] [ \begin{matrix}0.5 P \\ 0.5 P\end{matrix} ] + [ \begin{matrix}{x}_{o} \\ {y}_{o}\end{matrix} ] \qquad ( 1 )$$

Where xₜ and yₜ are coordinates of the pixel at a time “t” at each sub-frame time, and xₒ and yₒ are the coordinate location of the pixel when the PCMs are OFF. FIG. 6E shows this matrix and how it may be used to increase the resolution. As shown, a pixel 11 is surrounded with a black, non-active area. In this design, on top of the pixel, PCMs (not depicted here), may be placed.

Depending on how the PCMs are activated, at each time the pixel can stay at where it is

$$[ \begin{matrix}0 & 0 \\ 0 & 0\end{matrix} ]$$

or be shifted upward

$$[ \begin{matrix}0 & 0 \\ 0 & 1\end{matrix} ] ,$$

toward the right

$$[ \begin{matrix}1 & 0 \\ 0 & 0\end{matrix} ] ,$$

or upward and toward the left

$$[ \begin{matrix}1 & 0 \\ 0 & 1\end{matrix} ] .$$

Dividing one frame into four sub-frames

$$( e . g . , \frac{240}{4} = 60 Hz )$$

the pixel density may be multiplied by a factor of four, two added horizontally and two added vertically. With this approach, the combined image may have a 2000×2000 resolution with a 60 Hz frame rate.

As depicted by FIG. 6F, the opposite of foregoing method may also be used to provide a higher frame rate at the cost of reducing spatial resolution. In that case, at each time one of the pixels (P₁, P₂, P₃, or P₄) is shifted to the location shown by the plus sign in FIG. 6F. Here, the superpixel is a combination of 4 pixels (P₁, P₂, P₃, and P₄), on top of which is an aperture. The aperture opening is designed to be the size of one pixel and located at the center of the superpixel (shown by a plus sign). PCMs 4 are also sandwiched between the pixel and aperture (not shown here). At each time t, this superpixel only shows one of the P1-P4 pixels, and it is represented by the matrix given by Equation (2):

$$Pixel ( t ) = [ \begin{matrix}a & bc & d\end{matrix} ] [ \begin{matrix}{P}_{1} \\ {P}_{2} \\ {P}_{3} \\ {P}_{4}\end{matrix} ] \qquad ( 2 )$$

In the case of [a b c d]=[0 0 0 0] the user cannot see any of the four pixels since none of them are shifted by the PCM (i.e., PCMs are OFF) and there is an aperture blocking the user to see them directly. The aperture is shown by the semi-transparent layer 10 in FIG. 6F. In the case of [1 0 0 0], pixel P1 is shifted to the down left position and can be observed by the user. In the case of [0 1 0 0], pixel P₂, the case of [0 0 1 0], pixel P₃, and finally in the case of [0 0 0 1], pixel P₄ are shifted appropriately and can be seen by the user. Here, it is assumed that the response time or frame rate of the PCM is much faster than that of the original display. For example, in this case it is at least 4 times faster. Using this approach, the location of the pixel that can be seen by the user is always fixed but at each time it shows different content from one of the four pixels around it. So, the frame rate is multiplied by a factor of four. The trade-off here is the spatial resolution also reduces by a factor of four.

### Depth Control Module/Component

As described herein, a depth control module 5 may be used to shift the monocular depth at which users perceive images

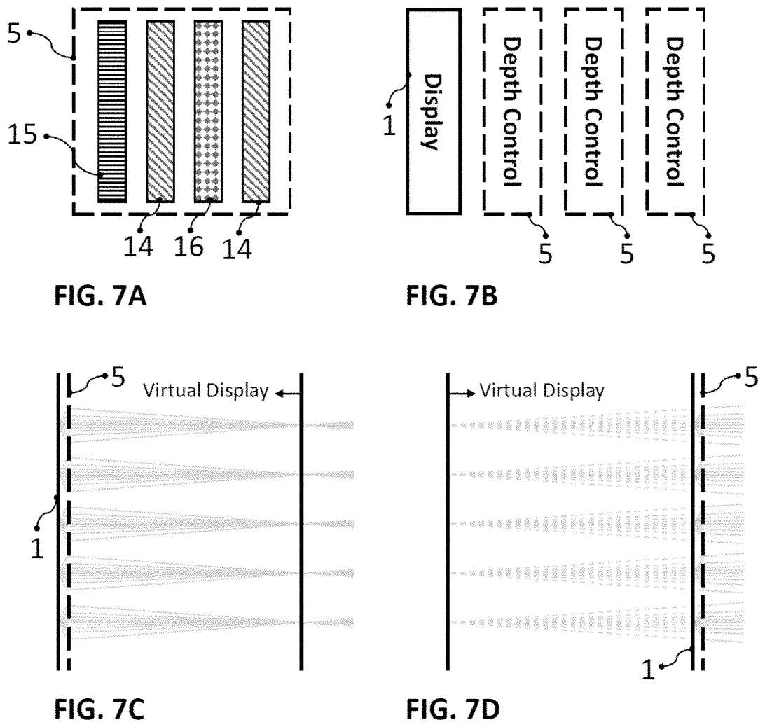

FIGS. 7A-D show an implementation of a dynamic depth control module based on a meta-lenses design, in accordance with some implementations of the disclosure.

FIG. 7A is a block diagram illustrating an example structure of the depth control module 5. The depth control module 5 includes a polarizer 15 that polarizes input light and an array of polarization-dependent meta-lens array 16 between a first switchable HWP 14 and a second switchable HWP 14. The polarizer 15 before the first switchable HWP 14 is optional, and it may be used to set the input polarization if required. The meta-lenses may reimage display pixels at a design location (for example in front of the physical display 1 as shown in FIG. 7C) for a desired polarization, and let the other polarization pass through unchanged (switchable functionality via controlling input polarization). In other words, the meta-lens array may shift the monocular depth where users perceive images. Meta-lenses may make the virtual image by pushing the depth backward, behind the physical display, as shown in FIG. 7D. Because meta-lenses are polarization-dependent, the depth may be switched between two discrete levels, where the meta-lens forms an image at a first depth for one polarization and a second depth for a second polarization that is orthogonal. More than two discrete depths may be obtained by cascading multiple depth control modules as depicted by FIG. 7B.

### Color Corrector Module/Component

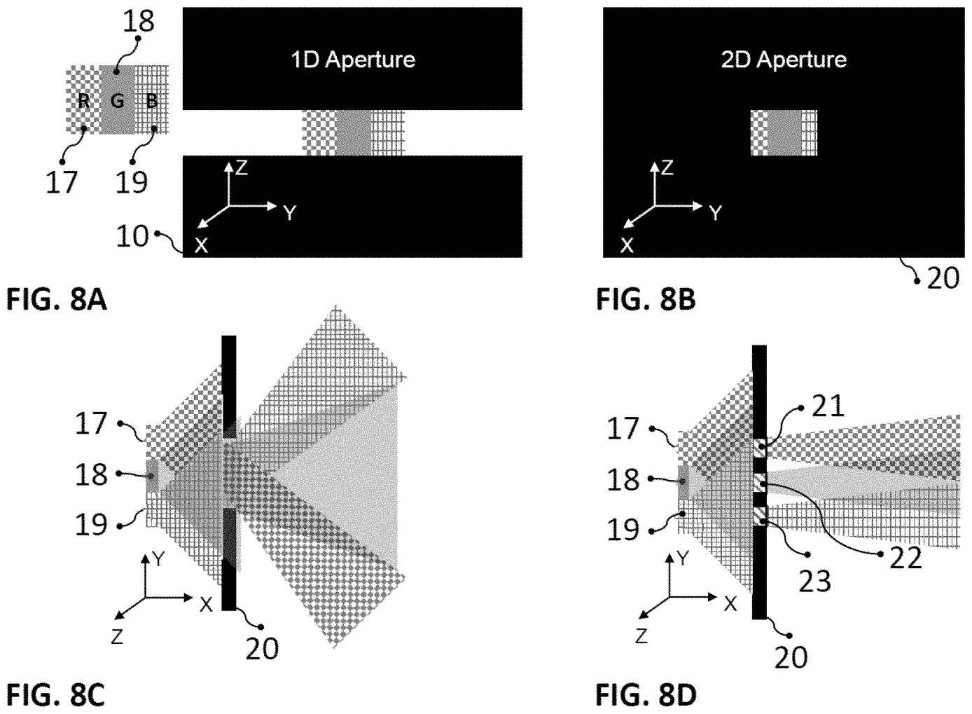

FIGS. 8A-D show a Color Corrector Module (CCM) based on apertures combined with color filters, in accordance with some implementations of the disclosure. Many displays utilize a super-pixel consisting of a red subpixel 17, a green subpixel 18, and a blue sub-pixel 19 (RGB) as depicted by FIG. 8A. For the case of a 1D aperture 10, the angular distribution of each color after the aperture is similar (ignoring the diffraction effect that is color-dependent). Because we are dealing with a 1D aperture, which is infinitely long along the Y-axis, the aperture does not limit the angular distribution of pixels along the Y-axis. Along the Z-axis, each color pixel sees an aperture with the same width and distance from its center (note that the aperture is infinitely long along the Y-axis); therefore, the angular distribution of each pixel after the aperture is the same. However, as depicted by FIG. 8B, the situation is different for a 2D aperture 20 where the aperture has a limited length along both Y-axis and Z-axis. When the width and length of the 2D aperture are comparable with the size of each pixel, the aperture modifies the angular distribution of each pixel along with both the Y-axis and the Z-axis. Ignoring the color-dependent diffraction effect, the aperture similarly modifies the angular distribution of each color pixel along the Z-axis. However, as depicted by FIG. 8C, along the Y-axis, the center of the aperture is not aligned with the center of Red and Blue sub-pixel anymore, resulting in the different angular distribution of output light for these color sub-pixels compared to green sub-pixels. This misalignment also leads to some color artifacts (e.g., color moire) and cross-talk between neighboring pixels.

As depicted by FIG. 8D, one way to overcome this problem is to use one aperture for each color pixel, in which case each aperture is filled by a color filter that only allows the light from a pixel in front of it to pass through. For example, the red filter 21 in front of the red pixel only allows the red color to pass through and blocks the green and blue colors. Similarly, the green filter 22 is placed in front of the green pixel 18, and the blue filter 23 is placed in front of the blue pixel 19. Because each color pixel sees the same aperture (in terms of aperture size, aperture distance, and how aperture is aligned with the pixel), the angular distribution of all red, green, and blue light after the aperture is the same. In the end, there is a slight location shift between different colors after the aperture, but it is small and is comparable to the distance between each color pixel (e.g., tens of micrometers depending on the pixel size of the display) and it is negligible to the headbox (the viewing zone where the users head can see the image correctly) of a user, which may be tens of centimeters depending on the type of display system. Similar to previous aperture cases, any spatial filtering may reduce brightness.

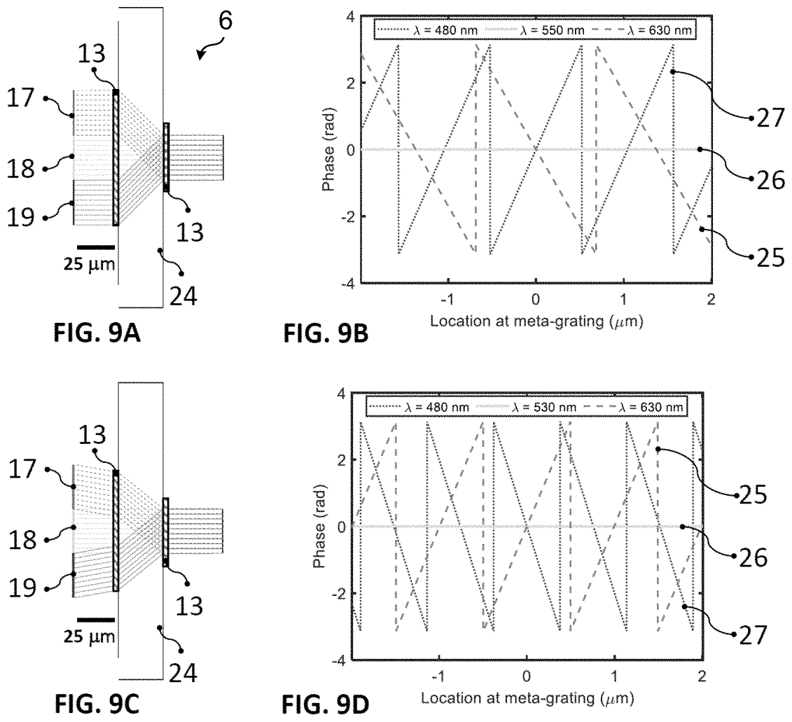

FIGS. 9A-D show an implementation of a dynamic CCM 6 based on a meta-gratings design, in accordance with some implementations of the disclosure. This design can be used to correct for color artifacts. In the design of FIG. 9A, the CCM 6 places two meta-gratings 13 on opposite sides of a substrate 24. This design combines three pixels (RGB) into one white pixel to avoid the color artifact issue discussed above with reference to FIG. 8C. FIG. 9B shows the required phase profiles (25,26,27) at three colors: red (25), green (26), and blue (27). This phase refers to the phase impact on a coherent light at the center wavelength of individual color channels RGB that is induced by means of transmission through these layers. The first meta-grating 13 (on the left, FIG. 9A) diffracts the red rays downward, does not affect the green rays (also obvious since the phase profile is zero for green (FIG. 9B)), and diffracts blue rays upward. The second meta-grating 13 (on the right, FIG. 9A) diffracts back red and blue rays to their original angles and does not affect the green rays, and therefore combines all three colors into one ray bundle. FIGS. 9C-D also show the same concept for rays with different angles showing the concept work regardless of the angular distribution of the rays.

### Utilizing Control Modules In Different Display or Imaging Systems

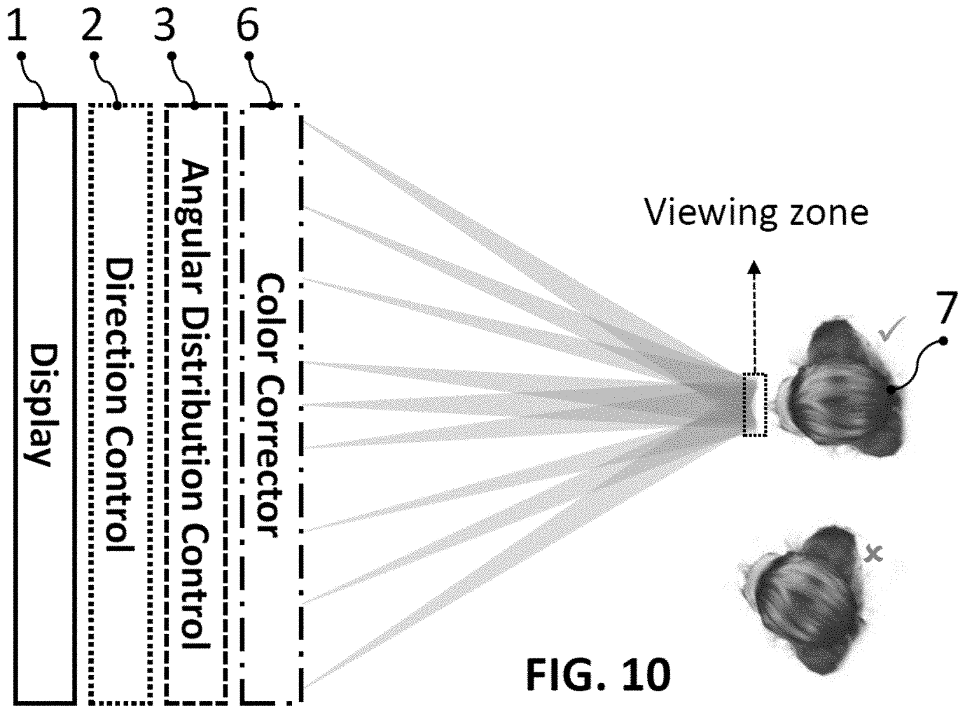

FIG. 10 shows a dynamic control of the viewable zone of a display 1 by stacking several control modules, in accordance with some implementations of the disclosure. In this embodiment, the display system stacks a DCM 2, an ADCM 3, and a CCM 6 in front of a display 1. By following this arrangement, the system may be able to dynamically change the location of the viewable zone or extend the viewable zone (i.e., the zone where a user can see content generated by the display 1. In this example, the DCM 2 controls where each pixel goes (toward which user), the ADCM 3 controls the size of the viewable zone by adjusting the angular distribution of rays, and the CCM 6 corrects for any possible color effect generated in the display system to deliver high-fidelity content to the user 7.

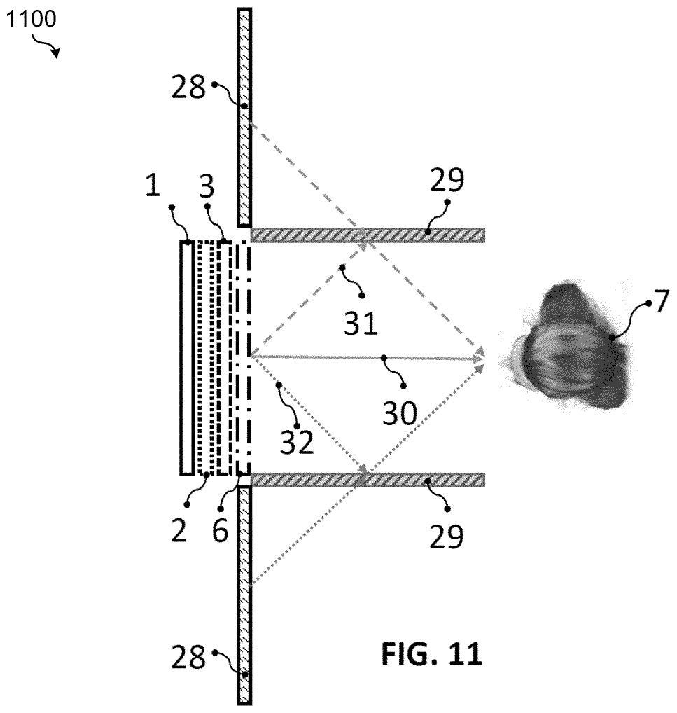

FIG. 11 shows a tessellated display system that may expand the display size by stacking several control modules together with mirrors using a tessellation mechanism, in accordance with some implementations of the disclosure. The depicted tessellated display system includes a display 1, a DCM 2, an ADCM 3, a CCM 6, and mirrors 29. In some implementations, the mirrors may be implemented in a field evolving cavity. To appreciate the operation of the tessellated display system, consider each time at which a high frame rate display shows one image/content. If the frame rate of the display is synched with one or more DCM modules 2 that are placed in front of the display, each image may be sent in a desired direction. For simplicity, assume the DCM 2 sends the first image to the forward direction 30, the image to the top direction 31, and the third image to the bottom direction 32. If two mirrors 29 are placed normal to the surface of the display, the top and bottom images may be redirected toward the viewable zone of user 7. The user 7, without needing to change position, may see different images depending on the user's viewing angle (eye-gaze). Here, utilizing the DCM concept, the system starts from one display and multiplies each dimension by three times, expanding the viewed image by nine times in the area, one physical display 1, and two virtual display 28. As also shown in FIG. 11, and ADCM 3, CCM 6, and any other of the modules discussed in the present disclosure may be stacked to increase the functionality and add new features to the display system. It should be noted that depending on the implementation, the tessellated display system may include more than two mirrors. For example, the tessellated display system may include four mirrors or a hexagonal field evolving cavity having six mirrors. Additional examples of field evolving cavities with which the cascaded control modules described herein may be utilized are further described in U.S. Patent Publication No. 20210006763A1, titled “systems and methods for virtual light field expansion with electro-optical tessellation.”

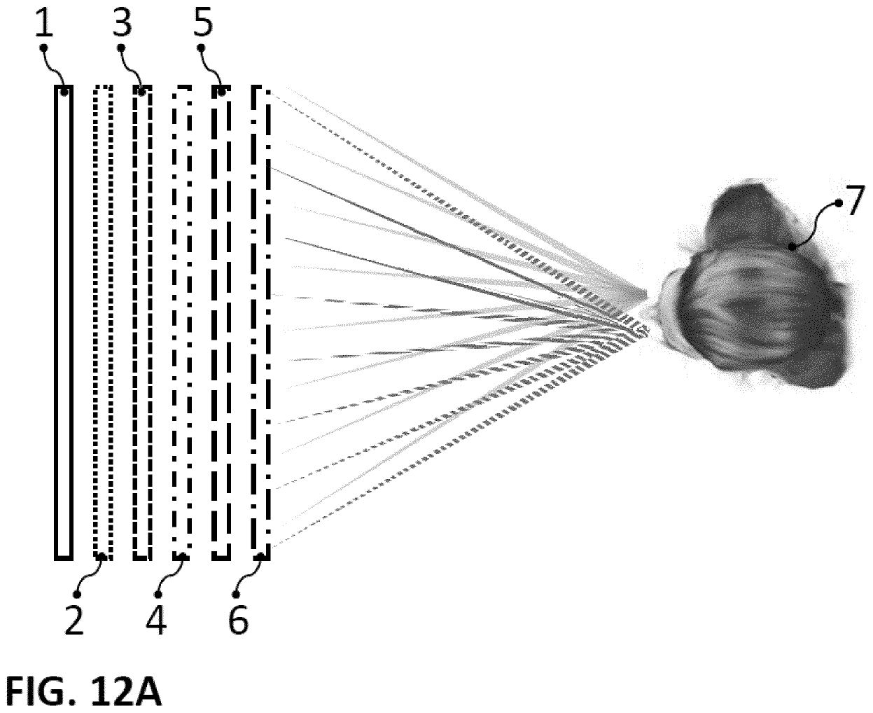

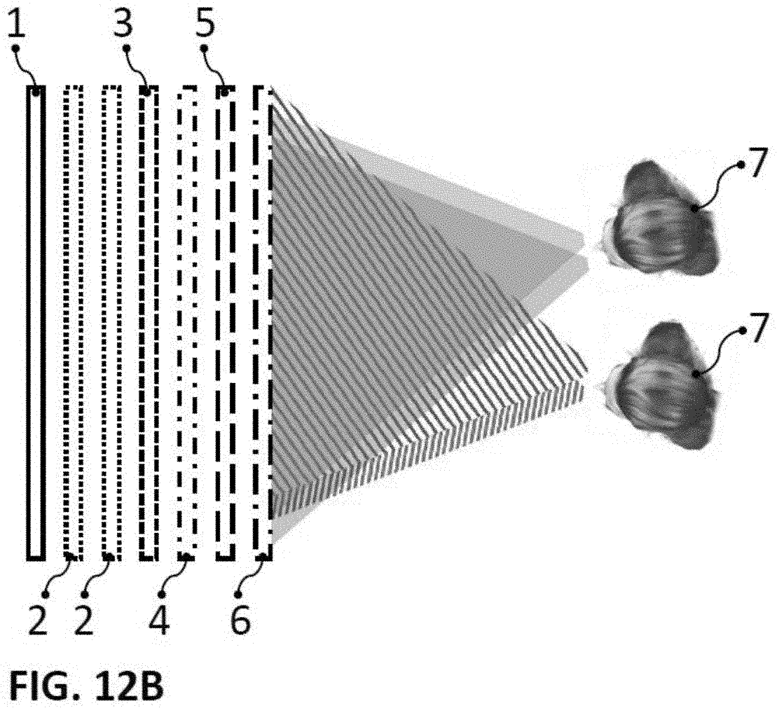

FIGS. 12A-12B show example implementations of display systems that stack several control modules in front of a display 1 to dynamically change the depth of the display and generated 3D contents, in accordance with some implementations of the disclosure.

FIG. 12A shows that by stacking several controlling modules (2)-(6) in front of a high frame rate display, at any given time the system can redirect rays emanating from the display 1 (e.g. images, frames) toward the left or right eye of the user 7. If this is done faster than the user eye response time (typically 60 Hz and above), the user will perceive two different contents for the left and right eye. Content may be very similar with a slight coordinate shift based on the well-known stereoscopic parallax to generate autostereoscopic 3D perception.

In this example time multiplexing is used, but the same concept can be achieved via pixel multiplexing. Where, for example, half of display pixel arrays show one content and the other half different contents, using the control module the direction and angular distribution of ray segments may be changed to generate a 3D effect that does not require a high frame rate display. As evident from FIG. 12A, this specific design has a limited headbox (the viewable zone where the user's head needs to be placed to see the 3D effect correctly). The display system of FIG. 12B shows how one can multiply the headbox or increase the number of users by stacking extra DCM 2. There is a tradeoff between the number of users and the display resolution/and or frame rate. If spatial multiplexing is done, the resolution of the image seen per eye is equal to the original resolution of the display divided by twice the number of users.

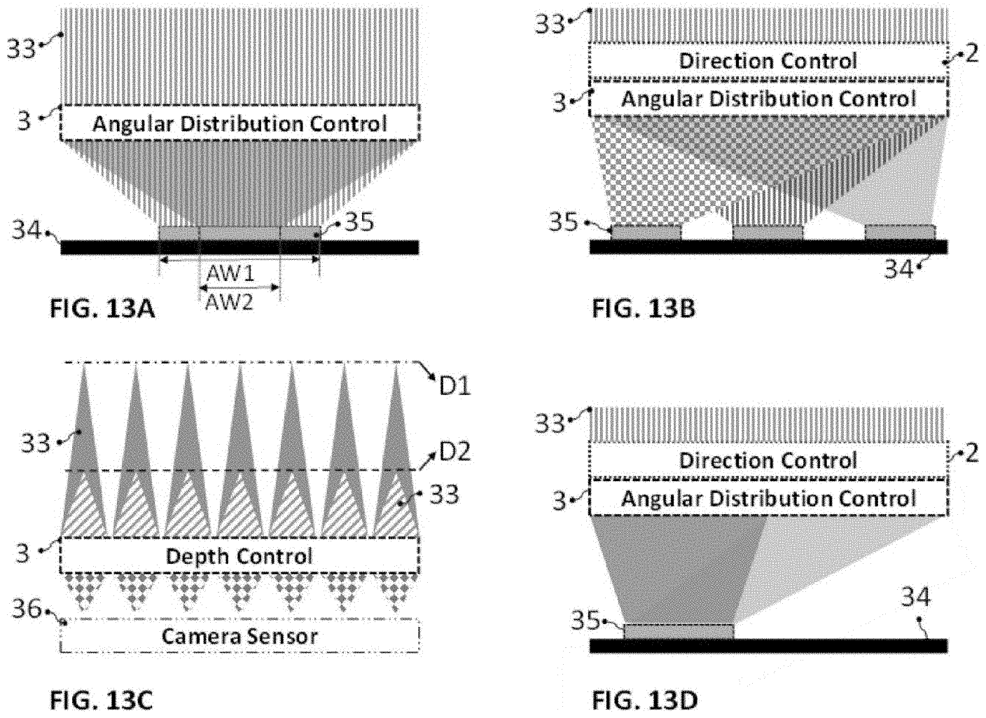

FIG. 13A-D show several non-limiting embodiments where control modules are used for imaging purpose in imaging systems, in accordance with some implementations of the disclosure.

FIG. 13A shows an embodiment of an imaging system where an ADCM 3 is integrated on top of the detector/imaging sensor with an arbitrary pixel size and filling factor. As shown, if the active region width (AW) of a pixel 35 changes because of the change in the wavefront of the incident light, ADCM 3 adjusts the angular distribution of transmitted light in such a way to enhance the coverage area on each sensor pixel, enhancing efficiency. For example, if the AW reduces from AW1 to AW2, ADCM 3 converges the transmitted light further to make sure all photons impinge on the active region area of the sensor, thus increasing the signal to noise ratio of the sensor.

FIG. 13B shows one embodiment of an imaging system where DCM 2 and ADCM 3 are stacked to adjust both direction and angular distribution of incoming light 33 in such a way that at each time interval (shorter than the frame rate of the sensor) transmitted light impinges on a different pixel 35 of the sensor. In the normal case, without DCM 2 and ADCM 3, the incoming light, part of the imaging scene, goes to three pixels (left, center, and right). Here, the spatial resolution is reduced by a factor of three (factor of nine if both dimensions are considered) and all of this light goes to one pixel at a time. In this example, the response time of DCM 2 and ADCM 3 should be at least three times (nine times if the sensor is 2D) faster than that of the sensor to capture three (or nine in 2D sensor) frames (each frame interval time is equal to ⅓ of the sensor), which was not possible before. Thus, the frame rate is increased by a factor of three.

FIG. 13C shows an embodiment of an imaging system that integrates a depth control module on top of a camera sensor so that the imaging system can change the depth where the camera is capturing images from a scene, without any mechanical movement.

FIG. 13D shows an embodiment of an imaging system that cascades a DCM 2 and ADCM 3 to increase the spatial resolution of the sensor. In the case without DCM 2 and ADCM 3, the right-side portion of incoming light 33 will impinge on the non-active region of the pixel 34. Using DCM 2 and ADCM 3, at frame#1 the left portion of the incoming light will be redirected toward the active area of the pixel, and at frame#2 the right portion of the incoming light will be redirected toward the active area of the pixel 35. Here, by reducing the frame rate of the sensor by a factor of two, spatial resolution is doubled. Certainly, if the two dimensions of the sensor are considered, this can become a factor of four. Starting with a high frame rate camera sensor, we can keep dividing the frame rate and gain spatial resolution.

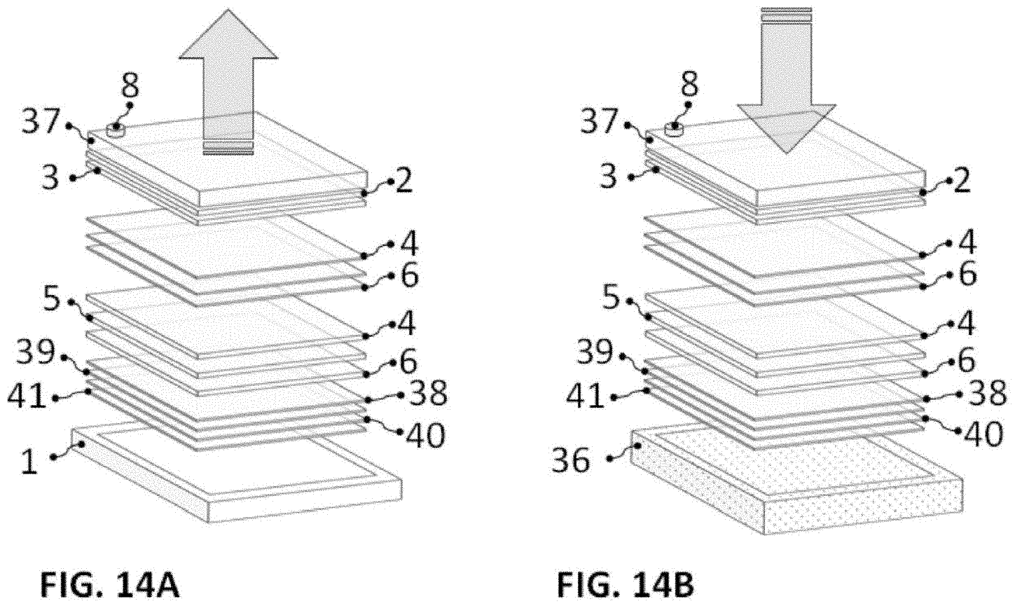

FIGS. 14A-B show some examples of how different control modules can be integrated with display or image sensors, in accordance with some implementations of the disclosure.

FIG. 14A shows one embodiment where control modules and several other optical components are cascaded and integrated into a display 1 to enhance or expand its functionality. For example, the furthest layer from the display can be a protective layer 37. The protective layer 37 may be made of plastic or glass coated with an anti-reflection film. Some other optical components can be wave plates 38, and polarizers 39 to adjust the polarization of transmitted or reflected light, a color filter 40, and privacy film. Here the order of components is shown for exemplary purposes, and the order and the number of components can be arbitrarily selected depending on the design goal.

The same embodiment can be used for an imaging system where the display is replaced with an imaging sensor 36 as shown in FIG. 14B. In this case, the light coming toward the image sensor is controlled to boost the functionality of the sensor and extract more parameters from incoming light in addition to its amplitude (which is a common function of a sensor) such as angular distribution and depth of the image, etc. The above-mentioned imaging and displays can be arbitrarily engineered to match any applications such as augmented reality and virtual reality headsets, cell phone screens, monitor screens, light field displays, 3D displays etc. For the imaging applications, these cascaded light controllers can impact the performance and brightness of cellphone cameras, scientific cameras, commercial cameras, industrial sensors, biomedical sensors, and imaging instruments such as endoscopes, microscopes, and other imaging apparatuses.

As the foregoing examples illustrate, by virtue of having the illustrated design including a metasurface between a first switchable HWP that may change the light polarization by 90 degrees, and a second switchable HWP, positioned after the metasurface, that may revert the light to its original polarization, it is possible to independently control the various cascaded optical control modules/components in a binary fashion. For example, a given optical control module may be switched on by turning “on” the first switchable HWP and the second switchable HWP such that, after passing through the first HWP, the light is of a suitable polarization to have one or more of its properties affected by the metasurface after it passes through the metasurface, and the light returns to its polarization (i.e., the polarization it had before passing through the first HWP) after passing through the second HWP. Continuing the same example, the optical control module may be turned off such that it appears transparent to the light passing through it (i.e., the light's polarization or other properties are not affected as it passes through the first HWP, the metasurface, and the second HWP).

Although primarily described in the context of using HWP that may change polarization by 90 degrees to enable binary switching on/off of an optical control module's state, the optical control modules described herein may be implemented with other tunable waveplates such as quarter waveplates, In such cases, it may be possible to realize more than two states in an optical control module. For example, in such cases the optical control module may include multiple cascaded tunable waveplates positioned after and/or before the metasurface, which enable the optical control module to function in three or more states.

One or more controllers (e.g., processor 9) may be utilized to deliver a control signal (e.g., voltage) to each of the waveplates to switch states of each of the optical control components. The one or more controllers may be electrically coupled (e.g., via suitable circuity) to each of the optical control modules to enable independent control of each of the modules.

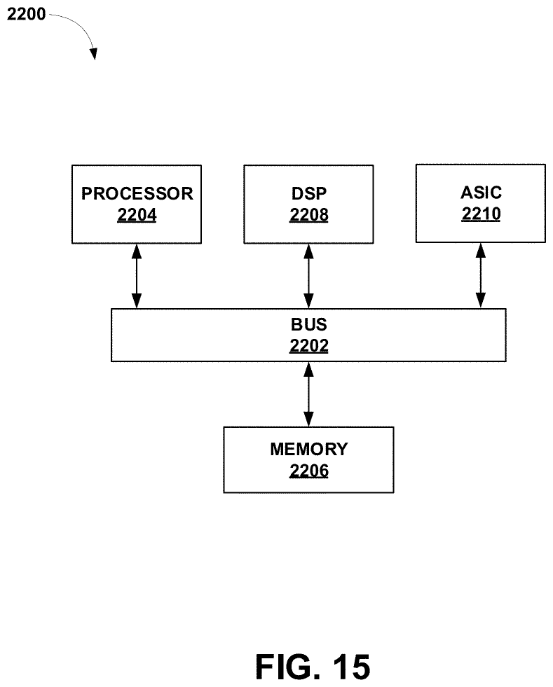

FIG. 15 illustrates a chip set 2200 in which embodiments of the disclosure may be implemented. For example, the chip set 2200 may be incorporated in any of the cascaded metasurface display systems or cascaded metasurface imaging systems described herein. Chip set 2200 can include, for instance, processor and memory components incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction. Cascaded

In one embodiment, chip set 2200 includes a communication mechanism such as a bus 2202 for passing information among the components of the chip set 2200. A processor 2204 has connectivity to bus 2202 to execute instructions and process information stored in a memory 2206. Processor 2204 includes one or more processing cores with each core configured to perform independently. A multi-core processor enables multiprocessing within a single physical package. Examples of a multi-core processor include two, four, eight, or greater numbers of processing cores. Alternatively or in addition, processor 2204 includes one or more microprocessors configured in tandem via bus 2202 to enable independent execution of instructions, pipelining, and multithreading. Processor 2204 may also be accompanied with one or more specialized components to perform certain processing functions and tasks such as one or more digital signal processors (DSP) 2208, and/or one or more application-specific integrated circuits (ASIC) 2210. DSP 2208 can typically be configured to process real-world signals (e.g., sound) in real time independently of processor 2204. Similarly, ASIC 2210 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

Processor 2204 and accompanying components have connectivity to the memory 2206 via bus 2202. Memory 2206 includes both dynamic memory (e.g., RAM) and static memory (e.g., ROM) for storing executable instructions that, when executed by processor 2204, DSP 2208, and/or ASIC 2210, perform the process of example embodiments as described herein. Memory 2206 also stores the data associated with or generated by the execution of the process.

In this document, the terms “machine readable medium,” “computer readable medium,” and similar terms are used to generally refer to non-transitory mediums, volatile or non-volatile, that store data and/or instructions that cause a machine to operate in a specific fashion. Common forms of machine readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are generally referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. Additionally, unless the context dictates otherwise, the methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A display system, comprising:
a display configured to emit light corresponding to an image; and
one or more optical control components configured to receive the light emitted by the display and modify one or more properties associated with the light as it passes through the one or more optical control components, wherein:
each of the one or more optical control components comprises a polarization-dependent metasurface;
the one or more properties associated with the light comprise: a direction the light travels, a position of the light, an angular distribution of the light, a perceived depth of the image corresponding to the light, or a wavelength of the light that is filtered; and
each of the one or more optical control components is configured to dynamically switch between a first state where the optical control component modifies at least one property of the one or more properties associated with the light, and a second state where the optical control component does not modify the at least one property.

2. The display system of claim 1, wherein a first optical control component of the one or more optical control components is configured to modify the direction the light travels, the metasurface of the first optical control component comprising a first metagrating configured to diffract the light at a first angle it passes through the metagrating.

3. The display system of claim 2, wherein the one or more optical control components comprise a plurality of optical control components configured to modify the direction the light travels, the plurality of optical control components including the first optical control component and a second optical control component cascaded with the first optical control component, the metasurface of the second optical control component comprising a second metagrating configured to diffract the light at the first angle as it passes through the second metagrating, wherein when the first and second optical control components are in the first state, the light is diffracted at two times the first angle after it passes through the first and second optical control components.

4. The display system of claim 1, wherein:
the one or more optical control components comprise a first optical control component adjacent a second optical control component;
the first and second optical control components are configured to modify the position of the light;
the metasurface of the first optical control component comprises a first metagrating configured to diffract the light at a first angle as it passes through the first metagrating; and
the metasurface of the second optical control component comprises a second metagrating configured to diffract the light at a second angle opposite the first angle as it passes through the second metagrating.

5. The display system of claim 1, wherein a first optical control component of the one or more optical control components is configured to modify the angular distribution of the light, the metasurface of the first optical control component comprising a meta-lens array configured to converge or diverge the light at a given polarization as it passes through the meta-lens array.

6. The display system of claim 1, wherein a first optical control component of the one or more optical control components is configured to modify the perceived depth of the image, the metasurface of the first optical control component comprising a meta-lens array configured to reimage one or more pixels associated with the image.

7. The display system of claim 1, wherein:
the one or more optical control components comprise a first optical control component including: a substrate having a first side and a second side opposite the first side, a first meta-grating on the first side of the substrate, a second meta-grating on the second side of the substrate;
the first metagrating is configured to diffract a first wavelength of the light at a first angle as it passes through the first metagrating, and not diffract a second wavelength of the light as it passes through the first metagrating; and
the second metagrating is configured to diffract the first wavelength of the light at a second angle, opposite the first angle, as it passes through the second metagrating, and not diffract the second wavelength of the light as it passes through the second metagrating.

8. The display system of claim 1, wherein each of the one or more optical control components is capable of switching between the first state and the second state at a frequency greater than a framerate of the display.

9. The display system of claim 7, wherein: the one or more optical control components of the display system are configured to shift the image by less than a length of a pixel of the image to create a higher resolution image at a lower frame rate.

10. The display system of claim 9, wherein:
the display comprises a plurality of display pixels; and
the one or more optical control components comprises multiple optical controls, each of the multiple optical control components positioned over a respective one of the multiple display pixels to shift the position of light emitted by the pixel when the optical control component is in the first state.

11. The display system of claim 8, wherein:
each of the one or more optical control components is capable of switching between the first state and the second state at a frequency at least two times greater than a framerate of the display.
the one or more optical control components of the display system are configured to create an image having a framerate at least two times greater than the display.

12. The display system of claim 1, wherein each of the one or more optical components comprises the polarization-dependent metasurface between a first tunable waveplate and a second tunable waveplate.

13. The display system of claim 12, further comprising: a controller configured to apply, for each of the one or more optical control components, a control signal to the first tunable waveplate that switches the optical control component between the first state and the second state, wherein in one of the first state and the second state the first tunable waveplate affects a polarization of light passing through it, and wherein in the other of the first state and the second state the first tunable waveplate does not affect the polarization of light passing through it.

14. The display system of claim 12, wherein the first tunable waveplate is a first switchable halfwave plate (HWP), and the second tunable waveplate is a second switchable HWP.

15. The display system of claim 14, wherein each of the first switchable HWP and the second switchable HWP comprises a liquid crystal.

16. The display system of claim 1, wherein each of the one or more optical components comprises the polarization-dependent metasurface between a first tunable wave plate and a cascaded set of tunable waveplates such that at each polarization angle or state the overall cascade performs a desired set of optical functionalities.

17. The display system of claim 2, wherein:
the display system is a tessellated display configured to expand a viewed size of the image;
the display system further comprises at least two mirrors placed normal to a surface of the display; and
the first optical component is configured to cause the light to travel in the direction of one of the two mirrors.

18. The display system of claim 1, wherein:
the one or more optical control components comprise a first optical control component and a second optical control component;
the first optical control component is configured to modify the direction the light travels to control a destination that the light travels to; and
the second optical component is configured to modify the angular distribution of the light to control a size of a viewable zone of the image.

19. An image capture system, comprising:
an aperture configured to receive light;
a first optical component configured to collect the light received at the aperture;
one or more optical control components configured to receive the light passed by the first optical component and modify one or more properties associated with the light as it passes through the one or more optical control components, wherein:
each of the one or more optical control components comprises a metasurface;
the one or more properties associated with the light comprise: a direction the light travels, a position of the light, an angular distribution of the light, a perceived depth of an image corresponding to the light, or a wavelength of the light that is filtered; and
each of the one or more optical control components is configured to switch between a first state where the optical control component modifies at least one property of the one or more properties associated with the light, and a second state where the optical control component does not modify the at least one property; and
an image sensor configured to receive the light after it passes through the one or more optical control components.

20. The image capture system of claim 19, where the one or more optical control components comprise:
a depth control module positioned over the image sensor, the metasurface of the depth control module comprising a meta-lens array configured to reimage one or more pixels associated with the image; or
an angular distribution control module positioned over the image sensor, the metasurface of the angular distribution control module comprising a meta-lens array configured to converge the light at a given polarization as it passes through the meta-lens array, thereby converging the light on an active region area of the image sensor.
